(19) United States
(12) Patent Application Publication
(10) Pub. No.: US 2004/0198353 A1
(43) Pub. Date: Oct. 7, 2004

(54) Method and apparatus for optimizing registration and paging in group communications

(76) Inventor: Roy Franklin Quick JR., San Diego, CA (US)

Correspondence Address: Qualcomm Incorporated, Patents Department, 5775 Morehouse Drive, San Diego, CA, 92121-1714, US

(21) Appl. No.: 10/183,895

(22) Filed: Jun. 25, 2002

(51) Int. Cl. H04Q 7/20

(52) U.S. Cl. 455/435.1; 455/436

(57) ABSTRACT

A method and apparatus for optimizing registration and paging in a group communication system uses mobility of the participating mobile stations to minimize the number of registrations performed by the participating mobile stations as well as the area of paging the participating mobile stations. When the participating mobile stations have a low mobility status, the base station reduces the area of paging the mobile stations so that the paging channel load is reduced.

### FIELD

The present invention relates to point to multi-point communications systems. More specifically, the present invention relates to methods and apparatus for optimizing the frequency of registrations as well as the area of paging a group of target mobile stations based on the mobility of the target mobile stations.

### BACKGROUND

In wireless communications systems, registration is the process by which the mobile station notifies the base station of its location, status, identification, slot cycle, and other characteristics. The mobile station informs the base station of its location and status so that the base station can efficiently page the mobile station when establishing a mobile station-terminated call. Paging a mobile station includes the act of seeking the mobile station when a call has been placed to that mobile station. To conserve system capacity, reduce service cost, and save battery life, it is desirable to minimize registration message traffic as well as paging channel load. However, the act of minimizing registration is accompanied by a considerable increase in the paging area, and hence an increase in the paging channel load, since the mobile station may move through many cells or sectors during the increased interval between registrations. Currently, registration and paging techniques are not optimized based on the status, e.g., mobility, of the mobile stations.

For example, a class of wireless services intended for quick, efficient, one-to-one or one-to-many (group) communication has existed in various forms for many years. In general, these services have been half-duplex, where a user presses a “push-to-talk” (PTT) button on a phone/radio to initiate a group call. If granted the floor, the talker then generally speaks for a few seconds. After the talker releases the PTT button, other users may request the floor. These services have traditionally been used in applications where one person, a “dispatcher,” needs to communicate with a group of people, such as field service personnel or construction site workers, which is where the “dispatch” name for the service comes from. Similar services have been offered on the Internet and are generally known as “voice chat.” A key feature of these services is that mobile stations participating in a group call generally tend to be low mobility. Therefore, registration and paging may be optimized accordingly.

There is a need, therefore, for mechanisms to minimize registration without having to page in a wider area. There is also a need to optimize registration and paging of a group of mobile stations based on the current status, e.g. mobility, of the participating mobile stations.

### SUMMARY

The disclosed embodiments provide novel and improved methods and apparatus for optimizing registration and paging of mobile stations in a wireless communication network. In one aspect, a method in a mobile station (MS) for registering the MS with a base station (BS) includes starting a first timer when the MS is powered up, detecting an event occurring in the MS, and registering the MS with the BS based on the detected event.

In one aspect, a method in a mobile station (MS) for signaling a base station (BS) to control paging the MS includes sending a first signal to the BS to page the MS using a first strategy, and sending a second signal to the BS to page the MS using a second strategy. In another aspect, a method in a base station (BS) for paging a mobile station (MS) includes paging the MS using a first strategy according to a first event, and paging the MS using a second strategy according to a second event.

In one aspect, an apparatus for optimizing registration and paging in a group communication systems includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of disclosed embodiments set forth below when taken in conjunction with the drawings, and wherein:

FIG. 1 illustrates a group communications system;

FIG. 2 illustrates an embodiment for a base station and a mobile station operating in FIG. 1;

FIG. 3 illustrates how several communication devices interact with a group call server;

FIG. 4 illustrates a call-setup process according to one embodiment;

FIG. 5 illustrates a state diagram for optimizing registration in a mobile station; and

FIG. 6 illustrates a state diagram for optimizing paging in a base station.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

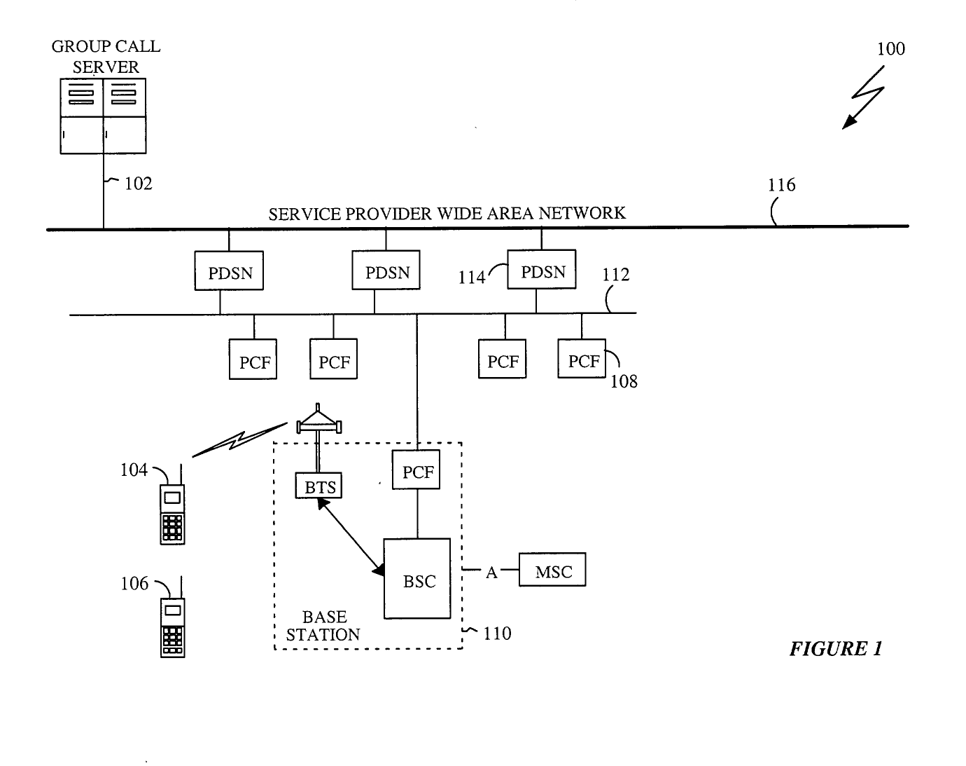

FIG. 1 illustrates a functional block diagram of a group communication system 100, for implementing one embodiment. Group communication system 100 is also known as a push-to-talk (PTT) system, a net broadcast service (NBS), a dispatch system; or a point-to-multi-point communication system. In one embodiment, group communication system 100 includes a group call server 102, which may be deployed in either a centralized deployment or a regionalized deployment.

Group communication devices (CDs) 104 and 106, which may be deployed such as cdma2000 handset, for example, may request packet data sessions using a data service option. Each CD may use the session to register its Internet Protocol (IP) address with the group call server to perform group call initiations. In one embodiment, group call server 102 is connected to the service provider's packet data service nodes (PDSNs) through a service provider's wide area network 116. CDs 104 and 106, upon requesting packet data sessions from the wireless infrastructure, may have IP connectivity to group call server 102 through a PDSN 114. The PDSNs provide interface between transmission of data in the fixed network and the transmission of data over the air interface. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, an active traffic channel exists between the participating CD and the BS or BSC, and either side may send data. In the dormant state, no active traffic channel exists between the participating CD and the BSC, but a point-to-point (PPP) link is maintained between the participating CD and the PDSN. In the null or inactive state, there is no active traffic channel between the participating CD and the BSC, and no PPP link is maintained between the participating CD and the PDSN.

After powering up, CDs 104 and 106 may request packet data sessions. As part of establishing a packet data session, each CD may be assigned an IP address. Each CD may perform a registration process to notify group call server 102 of the CD's IP address. Registration may be performed using an IP protocol, such as session initiation protocol (SIP) over user datagram protocol (UDP). The IP address of a CD may be used to contact the CD when the corresponding user is invited into a group call.

Once a group call is established, CDs 104 and 106 and group call server 102 may exchange media and signaling messages. In one embodiment, media may be exchanged between the participating CDs and the group call server by using real-time protocol (RTP) over UDP. The signaling messages may also be exchanged by using a signaling protocol over UDP.

Group communication system 100 performs several different functions in order to operate group call services. The functions that relate to the user side include user registration, group call initiation, group call termination, sending alerts to group participants, late join to a group call, talker arbitration, adding members to a group, removing members from a group, un-registering a member, and authentication. The functions that relate to system preparation and operation include administration and provisioning, scalability, and reliability. These functions are described in detail in the copending patent application entitled, “A Communication Device for Defining a Group in a Group Communication Network,” Attorney Docket No. PA020042, which is assigned to the same assignee and incorporated herein by reference in its entirety.

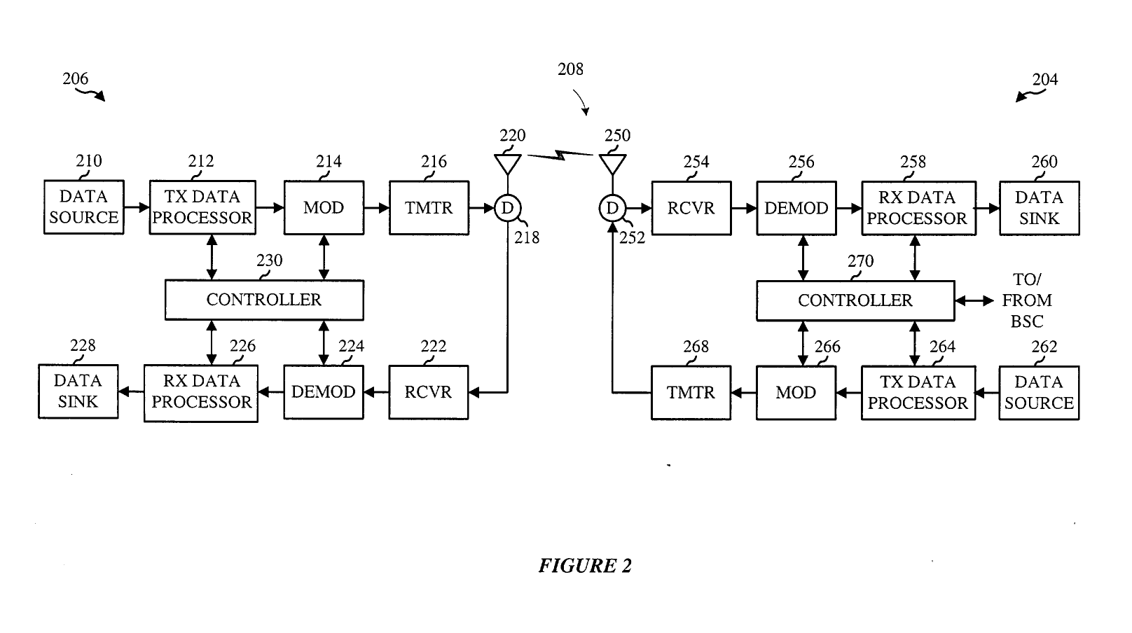

FIG. 2 is a simplified block diagram of an embodiment of base station 204 and mobile station 206, which are capable of implementing various disclosed embodiments. For a particular communication, voice data, packet data, and/or messages may be exchanged between base station 204 and mobile station 206, via an air interface 208. Various types of messages may be transmitted, such as messages used to establish a communication session between the base station and mobile station, registration and paging messages, and messages used to control a data transmission (e.g., power control, data rate information, acknowledgment, and so on). Some of these message types are described in further detail below.

For the reverse link, at mobile station 206, voice and/or packet data (e.g., from a data source 210) and messages (e.g., from a controller 230) are provided to a transmit (TX) data processor 212, which formats and encodes the data and messages with one or more coding schemes to generate coded data. Each coding scheme may include any combination of cyclic redundancy check (CRC), convolutional, turbo, block, and other coding, or no coding at all. The voice data, packet data, and messages may be coded using different schemes, and different types of messages may be coded differently.

The coded data is then provided to a modulator (MOD) 214 and further processed (e.g., covered, spread with short PN sequences, and scrambled with a long PN sequence assigned to the user terminal). The modulated data is then provided to a transmitter unit (TMTR) 216 and conditioned (e.g., converted to one or more analog signals, amplified, filtered, and quadrature modulated) to generate a reverse link signal. The reverse link signal is routed through a duplexer (D) 218 and transmitted via an antenna 220 to base station 204.

At base station 204, the reverse link signal is received by an antenna 250, routed through a duplexer 252, and provided to a receiver unit (RCVR) 254. Base station 204 may receive registration information and status information, e.g., mobile station mobility rate, from mobile station 206. Receiver unit 254 conditions (e.g., filters, amplifies, down converts, and digitizes) the received signal and provides samples. A demodulator (DEMOD) 256 receives and processes (e.g., despreads, decovers, and pilot demodulates) the samples to provide recovered symbols. Demodulator 256 may implement a rake receiver that processes multiple instances of the received signal and generates combined symbols. A receive (RX) data processor 258 then decodes the symbols to recover the data and messages transmitted on the reverse link. The recovered voice/packet data is provided to a data sink 260 and the recovered messages may be provided to a controller 270. Controller 270 may include instructions for paging a group of mobile stations, which may be based on the mobility of the mobile stations. The processing by demodulator 256 and RX data processor 258 are complementary to that performed at mobile station 206. Demodulator 256 and RX data processor 258 may further be operated to process multiple transmissions received via multiple, channels, e.g., a reverse fundamental channel (R-FCH) and a reverse supplemental channel (R-SCH). Also, transmissions may be simultaneously from multiple mobile stations, each of which may be transmitting on a reverse fundamental channel, a reverse supplemental channel, or both.

On the forward link, at base station 204, voice and/or packet data (e.g., from a data source 262) and messages (e.g., from controller 270) are processed (e.g., formatted and encoded) by a transmit (TX) data processor 264, further processed (e.g., covered and spread) by a modulator (MOD) 266, and conditioned (e.g., converted to analog signals, amplified, filtered, and quadrature modulated) by a transmitter unit (TMTR) 268 to generate a forward link signal. The forward link signal is routed through duplexer 252 and transmitted via antenna 250 to mobile station 206. Forward link signals include paging signals.

At mobile station 206, the forward link signal is received by antenna 220, routed through duplexer 218, and provided to a receiver unit 222. Receiver unit 222 conditions (e.g., down converts, filters, amplifies, quadrature modulates, and digitizes) the received signal and provides samples. The samples are processed (e.g., despreaded, decovered, and pilot demodulated) by a demodulator 224 to provide symbols, and the symbols are further processed (e.g., decoded and checked) by a receive data processor 226 to recover the data and messages transmitted on the forward link. The recovered data is provided to a data sink 228, and the recovered messages may be provided to controller 230. Controller 230 may include instructions for registering mobile station 206, which may be based on the mobility of the mobile station.

The group call service (GCS) may allow one user to talk to a group of users in a half-duplex or full-duplex mode. In the former case, because only one person may be permitted to talk at a time, the permission to talk may be moderated by the infrastructure. In such systems, a user may request permission to talk by pressing a “push-to-talk” button (PTT), for example. The system may arbitrate the requests received from multiple users and, through a contention-resolution process, the system may choose one of the requesters according to a predetermined algorithm. The system may then notify the chosen user that the user has permission to talk. The system may transparently dispatch the user's traffic information, such as voice and/or data, from the authorized talker to the rest of the group members, who may be considered “listeners.” The voice and/or data traffic in GCS may be different from the classical one-to-one phone call, and a priority may be placed on some conversations.

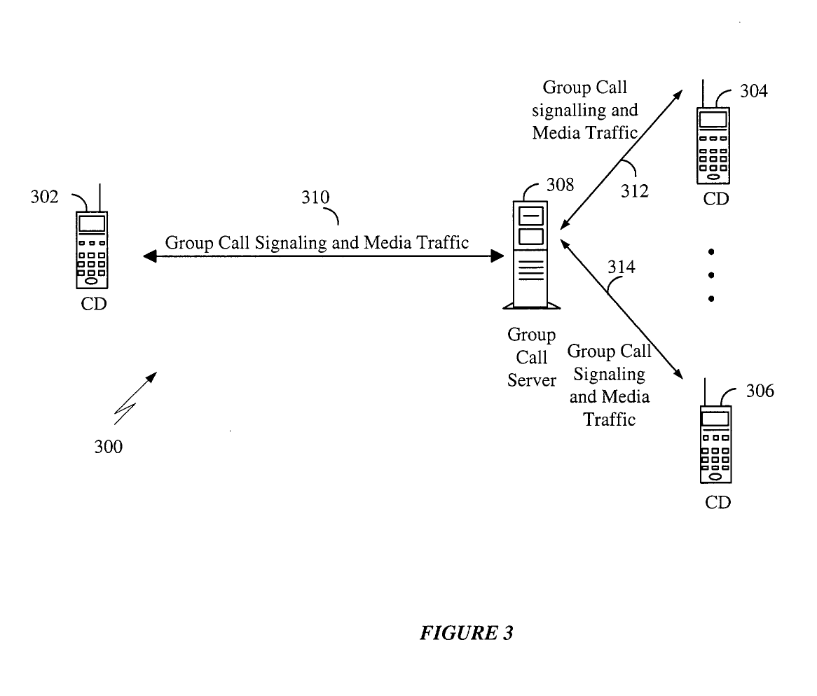

FIG. 3 illustrates a group call arrangement 300 for showing how CDs 302, 304, and 306 interact with a group call server 308. Multiple group call servers may be deployed as desired for large-scale groups. In FIG. 3, when CD 302 has permission to transmit media to other members of the group, CD 302 is known as the talker and may transmit media over an established channel. When CD 302 is designated as the talker, the remaining participants, CD 304 and CD 306, may not have permission to transmit media to the group. Accordingly, CD 304 and CD 306 are designated as listeners. As described above, CDs 302, 304, and 306 are connected to group call server 308, using at least one channel. In one embodiment, the channel may include a session initiation protocol (SIP) channel, a media-signaling channel, and a media traffic channel.

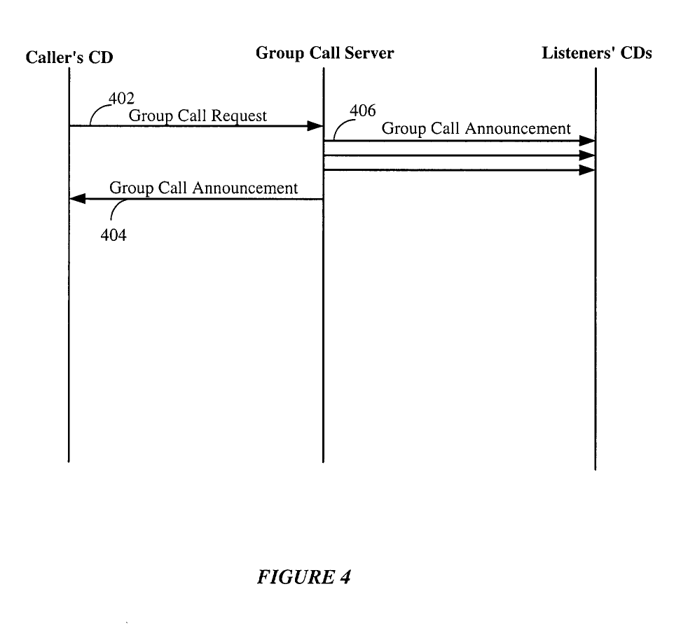

FIG. 4 illustrates a message-flow diagram showing a group call setup, according to one embodiment. A user who wishes to initiate a group call may select one or more target users, one or more pre-defined groups, or a combination of the two and may depress the push-to-talk (PTT) button on a CD. The caller's CD may then send a group call request 402 to the group call server to setup the group call. The caller's CD may be in a dormant packet data session when the caller initiates the group call. The group call request may be transmitted regardless of whether the caller's CD has a dedicated traffic channel or not, as will be discussed in more detail later. After the group call request is sent, if the caller's CD is in dormant packet data session, the caller's CD may initiate the process of re-establishing its dedicated traffic channel and prepare the packet data session for media activity.

When the group call server receives the group call request, the group call server may expand the pre-defined groups, if any is specified in the received group call request, into a list of group members. The group call server may retrieve location information for the desired group members. The group call server may also determine if the target group is already running in the system. FIG. 4 shows a scenario in which the group is not already running.

After the group call server locates at least one of the group members, the group call server may send a response 404 back to the caller's CD indicating that the group call is being set up. At this point, the caller's CD may optimistically grant the caller's request to talk. The caller's CD may start buffering the received media for future transmission to the group call server. The group call server may use the location information of the target listeners' CDs to send out announcements 406 to the target listeners' CDs. Sending the announcements may trigger the packet data sessions of the target listeners' CDs to come out of dormancy and to re-establish their traffic channels.

The “instant response” relates to the response time it takes for the group call server to respond to a PTT or group call request. The goal for responding to the PTT or group call request is to consistently respond to the request within a predetermined time period, e.g., one second or less. In many cases, when a caller requests to setup a group call, the caller's packet data session is dormant, meaning that no dedicated traffic channel exists. Re-establishing active channels may take considerable time.

In one embodiment, the group communication system supports both chat-room and ad-hoc models for group call services. In the chat-room model, groups are predefined, which may be stored on the group call server. The predefined groups, or nets, may be public, implying that the group has an open member list. In this case, each group member is a potential participant in a group call. The group call is started when a first group member starts to initiate a group call.

The call remains running for a pre-determined time period, which may be configured by the service provider. During a group call, the group members may specifically request to join or leave the call. During periods of talk inactivity, the group call may be brought into a group dormant state until a group member requests permission to talk. When operating in the chat-room model, group members, also known as net members, communicate with one another using a communication device assigned to each net member. The term “net” denotes a group of members authorized to communicate with each other.

In the ad-hoc model of group call services, however, groups may be defined in real-time and have a closed member list associated with each group. A closed member list may specify which members are allowed to participate in the group call. The member list may not be available to others outside of the closed member list, and may only exist for the life of the call. Ad-hoc group definitions may not be stored in the group call server. The definitions may be used to establish the group call and released after the call has ended. An ad-hoc group may be formed when a caller selects one or more target members and generates a group call request, which is sent to the group call server to start the call. The group call server may send a notification to the target group members that they have been included in the group. The group call server may automatically join the target members into the group call, i.e., no action may be required from the target members. When an ad-hoc call becomes inactive, the group communication server may “tear down” the call and free the resources assigned to the group, including the group definition used to start the call.

In one embodiment, a mobile station falls in one of two states. The mobile station may fall in a normal mobility state (NMS) when the mobile is determined to move in a large area beyond a cell or sector. The mobile station may fall in a limited mobility state (LMS) when the mobile is determined to move in a limited area such as within a cell or sector. When the mobile station is determined to be in the NMS, the base station may page the mobile station using a normal paging strategy, e.g., paging area and/or paging frequency, which may be established in part by the overhead channel messages. Such NMS paging mode may be directed to a large area consisting of multiple cells or sectors. However, when the mobile station is determined to be in the LMS, the base station may page the mobile station using a limited paging strategy, which may be according to the signal received from the base station indicating the low mobility status of the base station. Such LMS paging mode may be directed to a limited area such as a cell, a sector, or a small number of cells or sectors.

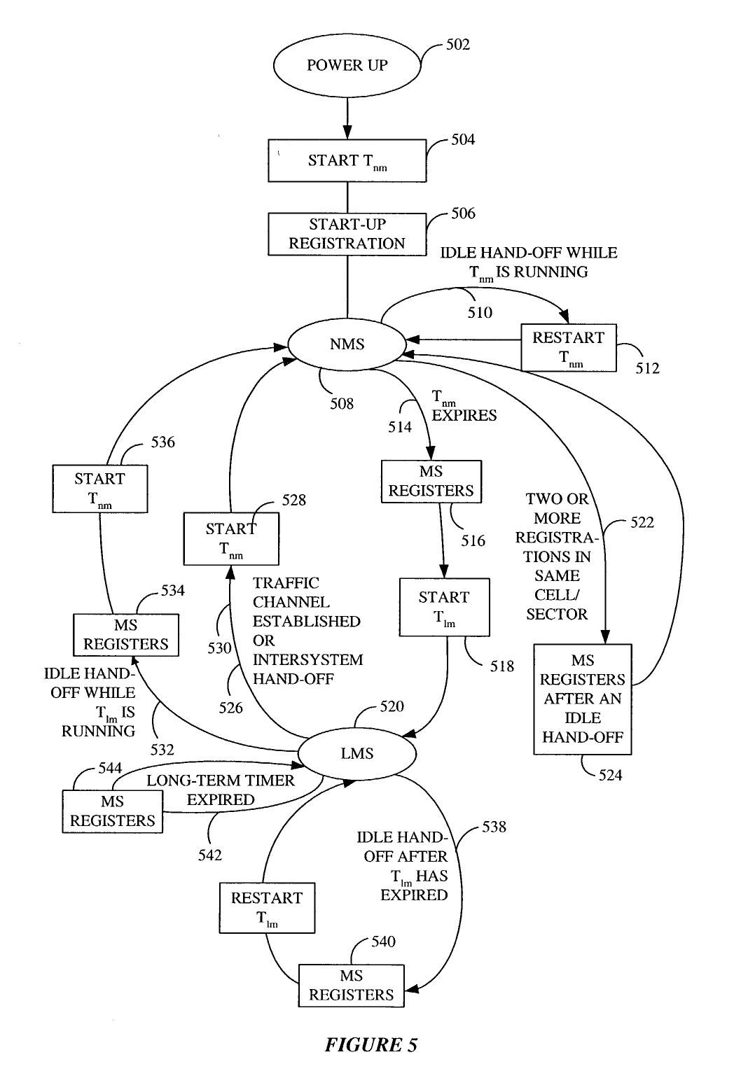

FIG. 5 shows a state diagram for optimizing registration, according to one embodiment. After a mobile station is powered up 502, the MS starts a first timer (Tₙₘ) 504, performs a power-up registration 506, if such registration is enabled, and enters the NMS state 508. When the mobile station performs an idle handoff 510 while the first timer is still running, which indicates that the MS is relatively moving rapidly from cell to cell, the mobile station restarts the first timer 512 and remains at the NMS state 508. An idle handoff includes the act of transferring reception of the paging channel, broadcast control channel or the forward common control channel from one base station to another when the mobile station is in the idle state.

While in the NMS state 508, the MS may perform registration as directed by the overhead messages, unless one of the following events occurs. The first event is when the first timer expires 514, indicating that the MS has stayed in the same cell or sector for a long time. When MS detects this event, the MS sends a registration message 516 to the BS, stops the first timer and starts a second timer (Tₗₘ) 518, and enters the LMS state 520.

The second event is when the MS performs two or more registrations in the same cell or sector while the MS is still in the NMS state 522. When MS detects this event, the MS sends a registration message 524 to the BS, after the MS performs an idle handoff, and remains in the NMS 508. The registration in the same cell or sector may cause the BS to assign the mobile station to the LMS, and this assignment may cause the BS to page based on a smaller paging area. An additional registration may be necessary to inform the BS that the MS has moved.

While in the LMS, the BS may transition back to the NMS state if one of the following events occurs. The first event is when the MS detects an intersystem handoff 526. When MS detects this event, which indicates that the MS has moved to a different BS that has no previous record of the MS's mobility state, the MS starts the first timer 528 and enters the NMS state 508.

The second event is when the MS detects that a traffic channel is re-established and subsequently released 530. Since no registration occurs while the MS is on a traffic channel, the mobile station's mobility state may not be determined while on a traffic channel. To maximize the likelihood of successful call delivery, the MS must operate in the NMS until its mobility state is determined. When MS detects this event, the MS starts the first timer 528 and enters the NMS state 508.

The third event is when the MS performs an idle handoff while the second timer is still running 532. When MS detects this event, which indicates that the MS is moving rapidly, the MS sends a registration message to the BS 534, starts the first timer 536, and enters the NMS state 508.

When the MS is in LMS 520, and the MS performs an idle handoff after the second timer has expired 538, the MS sends a registration message to the BS 540, restarts the second timer 522, and remains in the LMS state 520.

The MS also maintains a long-term timer that upon expiration triggers a slow-moving MS staying in the LMS state to re-register in the same sector. When the MS is in LMS 520, and the long-term timer expires 542, the MS registers 544, and then returns to LMS 520. The additional registration 544 allows a conservative strategy in the BS, which may sometimes erroneously assign the MS to the NMS in order to maximize the likelihood of successful call delivery. This may cause the BS to use a paging strategy that is inefficient until the state assignment is corrected. The additional registration 544 restores the correct mobility state in the event of such erroneous state assignment by the BS.

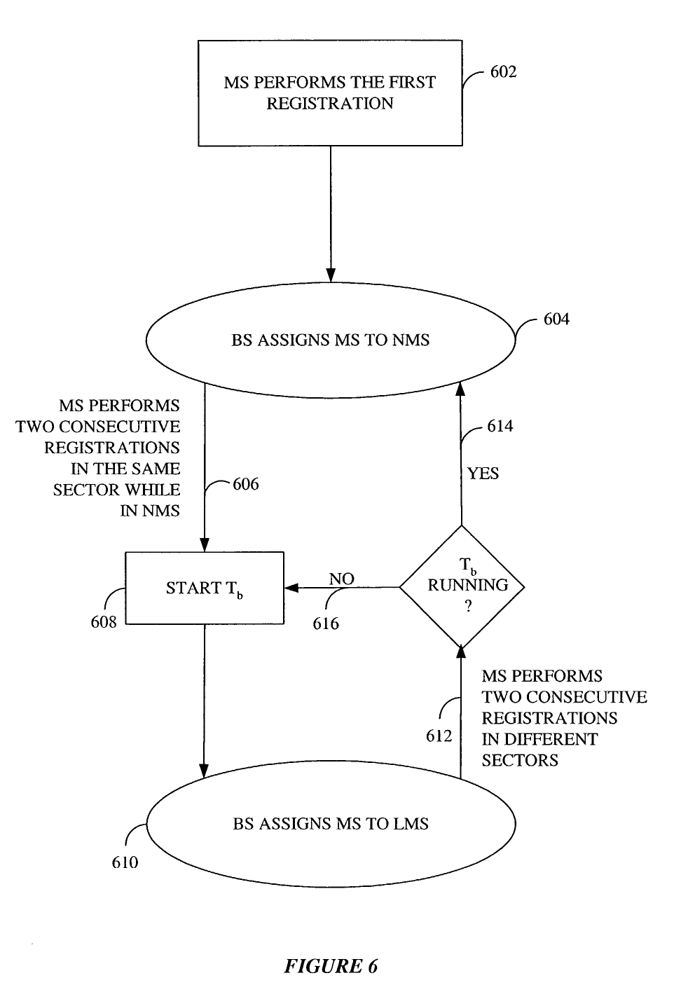

FIG. 6 shows a state diagram for paging optimization by the base station, according to one embodiment. The mobile station performs a first registration with the BS 602, e.g., a power-up registration, an intersystem idle handoff registration, or releases a traffic channel 602. When the BS receives such registration information from the mobile station, the BS assigns the MS to the NMS state 604. While the MS is in NMS state, the BS may page the MS according to the normal paging strategy, which may be established in part by the contents of the overhead messages. The MS may perform two or more registrations in the same cell or sector while the MS is still in the NMS state 604. When the BS receives such indication 606, which indicates that the MS is not moving rapidly, the BS starts a base timer (T_{b}) 608 and assigns the MS to the LMS 610. While the MS is in LMS state 610, the BS may page the MS using a limited paging strategy, paging area and/or paging frequency, hence reducing paging channel load. While in the LMS, the BS may reassign the MS to the NMS state if the MS performs at least two consecutive registrations in different cells or sectors 612 while T_{b} is still running 614, which indicates that the MS is moving rapidly. While in the LMS, the MS remains in LMS state 610 if the MS performs at least two consecutive registrations in different cells or sectors 612 after T_{b} has expires 616, which indicates that the MS is moving slowly.

As mentioned above, the BS may sometimes erroneously assign the MS to the NMS in order to maximize the likelihood of successful call delivery. The BS may use a conservative strategy as described above. The conservative strategy includes setting the times as T_{b}>Tₗₘ>Tₙₘ, indicating that the base station may not miss any transitions from LMS to NMS but may miss a few transitions from NMS to LMS. The long-term timer in the MS may be set to be larger than the T_{b} to ensure that the state eventually is corrected.

Therefore, the disclosed embodiments provide for a significant reduction in the frequency of registrations by the mobile stations as well as the area of paging the mobile stations in a group communication system. The disclosed methods and apparatus also provide for optimizing the registration and the paging load based on the mobility of the mobile stations.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.”

1. A method in a mobile station (MS) for registering the MS with a base station (BS), the method comprising:
starting a first timer when the MS is powered up;
detecting an event occurring in the MS; and
registering the MS with the BS based on the detected event.

2. The method of claim 1, wherein said detecting includes detecting an idle handoff following a plurality of registrations performed in one sector before expiration of the first timer.

3. The method of claim 1, wherein said detecting includes detecting expiration of the first timer.

4. The method of claim 3, wherein said registering includes starting a second timer after the expiration of the first timer.

5. The method of claim 4, wherein said detecting further includes detecting an idle handoff before expiration of the second timer.

6. The method of claim 4, wherein said detecting further includes detecting an idle handoff after expiration of the first timer.

7. The method of claim 1, wherein said detecting includes detecting when a long-term timer has expired.

8. A mobile station (MS), comprising:
means for starting a first timer when the MS is powered up;
means for detecting an event occurring in the MS; and
means for registering the MS with a base station (BS) based on the detected event.

9. The MS of claim 8, wherein said means for detecting includes means for detecting an idle handoff following a plurality of registrations performed in one sector before expiration of the first timer.

10. The MS of claim 8, wherein said means for detecting includes means for detecting expiration of the first timer.

11. The MS of claim 10, wherein said means for registering includes means for starting a second timer after the expiration of the first timer.

12. The MS of claim 11, wherein said means for detecting includes means for detecting an idle handoff before expiration of the second timer.

13. The MS of claim 11, wherein said means for detecting includes means for detecting an idle handoff after expiration of the first timer.

14. The MS of claim 8, wherein said detecting includes detecting when a long-term timer has expired.

15. A computer-readable medium storing codes for enabling a processor to perform a method for registering a mobile station (MS) with a base station (BS), the method comprising:
starting a first timer when the MS is powered up;
detecting an event occurring in the MS; and
registering the MS with the BS based on the detected event.

16. The computer-readable medium of claim 15, wherein said detecting includes detecting an idle handoff following a plurality of registrations performed in one sector before expiration of the first timer.

17. The computer-readable medium of claim 15, wherein said detecting includes detecting expiration of the first timer.

18. The computer-readable medium of claim 17, wherein said registering includes starting a second timer after the expiration of the first timer.

19. The computer-readable medium of claim 18, wherein said detecting further includes detecting an idle handoff before expiration of the second timer.

20. The computer-readable medium of claim 18, wherein said detecting further includes detecting an idle handoff after expiration of the first timer.

21. The computer-readable medium of claim 15, wherein said detecting includes detecting when a long-term timer has expired.

22. A mobile station (MS) comprising:
a receiver capable of receiving information from a base station (BS);
a transmitter capable of transmitting information to the BS; and
a processor capable of carrying out a method for registering the MS with a base station (BS), the method comprising:
starting a first timer when the MS is powered up;
detecting an event occurring in the MS; and
registering the MS with the BS based on the detected event.

23. The MS of claim 22, wherein said detecting includes detecting an idle handoff following a plurality of registrations performed in one sector before expiration of the first timer.

24. The MS of claim 22, wherein said detecting includes detecting expiration of the first timer.

25. The MS of claim 24, wherein said registering includes starting a second timer after the expiration of the first timer.

26. The MS of claim 25, wherein said detecting further includes detecting an idle handoff before expiration of the second timer.

27. The MS of claim 25, wherein said detecting further includes detecting an idle handoff after expiration of the first timer.

28. The MS of claim 22, wherein said detecting includes detecting when a long-term timer has expired.

29. A method for signaling a base station (BS) to control paging a mobile station (MS), the method comprising:
sending a first signal to the BS to page the MS using a first strategy; and
sending a second signal to the BS to page the MS using a second strategy.

30. The method of claim 29, wherein said sending the first signal includes starting a first timer.

31. The method of claim 30, wherein said sending the first signal includes sending the first signal after powering the MS.

32. The method of claim 30, wherein said sending the first signal includes restarting the first timer when detecting an idle handoff while the first timer is still running.

33. The method of claim 30, wherein said sending the second signal includes sending the second signal when the first timer expires.

34. The method of claim 33, wherein said sending the second signal includes starting a second timer.

35. The method of claim 34, wherein said sending the second signal includes restarting the second timer when detecting an idle handoff after the second timer has expired.

36. The method of claim 34, wherein said sending the first signal includes restarting the first timer when detecting an idle handoff before the second timer expires.

37. The method of claim 34, wherein said sending the first signal includes restarting the first timer when detecting an intersystem handoff.

38. The method of claim 34, wherein said sending the first signal includes restarting the first timer when detecting a traffic channel is re-established.

39. The method of claim 29, wherein the first strategy includes a first coverage area of the BS that is larger than a second coverage area of the BS that is included under the second strategy.

40. A mobile station (MS), comprising:
means for sending a first signal to a base station (BS) to page the MS using a first strategy; and
means for sending a second signal to the BS to page the MS using a second strategy.

41. The MS of claim 40, wherein said means for sending the first signal includes means for starting a first timer.

42. The MS of claim 41, wherein said means for sending the first signal includes means for sending the first signal after powering the MS.

43. The MS of claim 41, wherein said means for sending the first signal includes means for restarting the first timer when detecting an idle handoff while the first timer is still running.

44. The MS of claim 41, wherein said means for sending the second signal includes means for sending the second signal when the first timer expires.

45. The MS of claim 44, wherein said means for sending the second signal includes means for starting a second timer.

46. The MS of claim 45, wherein said means for sending the second signal includes means for restarting the second timer when detecting an idle handoff after the second timer has expired.

47. The MS of claim 45, wherein said means for sending the first signal includes means for restarting the first timer when detecting an idle handoff before the second timer expires.

48. The MS of claim 45, wherein said means for sending the first signal includes means for restarting the first timer when detecting an intersystem handoff.

49. The MS of claim 45, wherein said means for sending the first signal includes means for restarting the first timer when detecting a traffic channel is re-established.

50. The MS of claim 40, wherein the first strategy includes a first coverage area of the BS that is larger than a second coverage area of the BS that is included under the second strategy.

51. A computer-readable medium storing codes for performing a method for signaling a base station (BS) to page a mobile station (MS), the method comprising:
sending a first signal to the BS to page the MS using a first strategy; and
sending a second signal to the BS to page the MS using a second strategy.

52. The computer-readable medium of claim 51, wherein said sending the first signal includes starting a first timer.

53. The computer-readable medium of claim 52, wherein said sending the first signal includes sending the first signal after powering the MS.

54. The computer-readable medium of claim 52, wherein said sending the first signal includes restarting the first timer when detecting an idle handoff while the first timer is still running.

55. The computer-readable medium of claim 52, wherein said sending the second signal includes sending the second signal when the first timer expires.

56. The computer-readable medium of claim 55, wherein said sending the second signal includes starting a second timer.

57. The computer-readable medium of claim 56, wherein said sending the second signal includes restarting the second timer when detecting an idle handoff after the second timer has expired.

58. The computer-readable medium of claim 56, wherein said sending the first signal includes restarting the first timer when detecting an idle handoff before the second timer expires.

59. The computer-readable medium of claim 56, wherein said sending the first signal includes restarting the first timer when detecting an intersystem handoff.

60. The computer-readable medium of claim 56, wherein said sending the first signal includes restarting the first timer when detecting a traffic channel is re-established.

61. The computer-readable medium of claim 51, wherein the first strategy includes a first coverage area of the BS that is larger than a second coverage area of the BS that is included under the second strategy.

62. A mobile station (MS) comprising:
a receiver capable of receiving information from a base station (BS);
a transmitter capable of transmitting information to the BS; and
a processor capable of carrying out a method for signaling a base station (BS) to control paging the MS, the method comprising:
sending a first signal to the BS to page the MS using a first strategy; and
sending a second signal to the BS to page the MS using a second strategy.

63. The MS of claim 62, wherein said sending the first signal includes starting a first timer.

64. The MS of claim 63, wherein said sending the first signal includes sending the first signal after powering the MS.

65. The MS of claim 63, wherein said sending the first signal includes restarting the first timer when detecting an idle handoff while the first timer is still running.

66. The MS of claim 63, wherein said sending the second signal includes sending the second signal when the first timer expires.

67. The MS of claim 66, wherein said sending the second signal includes starting a second timer.

68. The MS of claim 67, wherein said sending the second signal includes restarting the second timer when detecting an idle handoff after the second timer has expired.

69. The MS of claim 67, wherein said sending the first signal includes restarting the first timer when detecting an idle handoff before the second timer expires.

70. The MS of claim 67, wherein said sending the first signal includes restarting the first timer when detecting an intersystem handoff.

71. The MS of claim 67, wherein said sending the first signal includes restarting the first timer when detecting a traffic channel is re-established.

72. The MS of claim 62, wherein the first strategy includes a first coverage area of the BS that is larger than a second coverage area of the BS that is included under the second strategy.

73. A method for paging a mobile station (MS), the method comprising:
paging the MS using a first strategy according to a first event; and
paging the MS using a second strategy according to a second event.

74. The method of claim 73, wherein the first event indicates that the MS has performed a first registration.

75. The method of claim 73, wherein the first event indicates that the MS has performed a plurality of registrations in one coverage area of a base station (BS).

76. The method of claim 75, wherein said one coverage area of the BS includes a sector.

77. The method of claim 75, further including starting a base timer.

78. The method of claim 77, wherein the first event indicates that the MS has performed a plurality of registrations in more than one coverage area of a base station (BS) while the base timer is still running.

79. The method of claim 73, wherein the first strategy covers a first coverage area of a base station (BS) that is larger than a second coverage area of the BS that is covered under the second strategy.

80. A base station, comprising:
means for paging a mobile station (MS) using a first strategy according to a first event; and
means for paging the MS using a second strategy according to a second event.

81. The BS of claim 80, wherein the first event indicates that the MS has performed a first registration.

82. The BS of claim 80, wherein the first event indicates that the MS has performed a plurality of registrations in one coverage area of a base station (BS).

83. The BS of claim 82, wherein said one coverage area of the BS includes a sector.

84. The BS of claim 82, further including means for starting a base timer.

85. The BS of claim 84, wherein the first event indicates that the MS has performed a plurality of registrations in more than one coverage area of a base station (BS) while the base timer is still running.

86. The BS of claim 80, wherein the first strategy covers a first coverage area of the BS that is larger than a second coverage area of a base station (BS) that is covered by the second strategy.

87. A computer-readable medium storing codes for performing a method in a base station (BS) for paging a mobile station (MS), the method comprising:
paging the MS using a first strategy according to a first event; and
paging the MS using a second strategy according to a second event.

88. The computer-readable medium of claim 87, wherein the first event indicates that the MS has performed a first registration.

89. The computer-readable medium of claim 87, wherein the first event indicates that the MS has performed a plurality of registrations in one coverage area of the BS.

90. The computer-readable medium of claim 89, wherein said one coverage area of the BS includes a sector.

91. The computer-readable medium of claim 89, the method further including starting a base timer.

92. The computer-readable medium of claim 91, wherein the first event indicates that the MS has performed a plurality of registrations in more than one coverage area of the BS while the base timer is still running.

93. The computer-readable medium of claim 87, wherein the first strategy covers a first coverage area of the BS that is larger than a second coverage area of the BS that is covered under the second strategy.

94. A base station (BS) comprising:
a receiver capable of receiving information from a mobile station (MS);
a transmitter capable of transmitting information to the MS; and
a processor capable of carrying out a method for paging a mobile station (MS), the method comprising:
paging the MS using a first strategy according to a first event; and
paging the MS using a second strategy according to a second event.

95. The BS of claim 94, wherein the first event indicates that the MS has performed a first registration.

96. The BS of claim 94, wherein the first event indicates that the MS has performed a plurality of registrations in one coverage area of the BS.

97. The BS of claim 96, wherein said one coverage area of the BS includes a sector.

98. The BS of claim 96, the method further including starting a base timer.

99. The BS of claim 98, wherein the first event indicates that the MS has performed a plurality of registration in more-than-one coverage area of the BS while the base timer is still running.

100. The BS of claim 94, wherein the first strategy includes a first coverage area of the BS that is larger than a second coverage area of the BS that is included under the second strategy.
